(19) United States
(12) Patent Application Publication
(10) Pub. No.: US 2022/0112834 A1
(43) Pub. Date: Apr. 14, 2022

(54) DEVICE FOR FUEL INJECTION FOR INTERNAL COMBUSTION ENGINES

(71) Applicant: Silvester CAMBAL, Hrnciarovce (SK)

(72) Inventor: Silvester CAMBAL, Hrnciarovce (SK)

(21) Appl. No.: 17/645,571

(22) Filed: Dec. 22, 2021

Related U.S. Application Data
(63) Continuation-in-part of application No. PCT/EP2020/000140, filed on Aug. 3, 2020.

(30) Foreign Application Priority Data
Sep. 11, 2019 (DE) 20 2019 105 016.0

(51) Int. Cl. F02B 19/08; F02B 19/10; F02B 23/10

(52) U.S. Cl. CPC F02B 19/08; F02B 19/1014; F02B 2023/108; F02B 23/10; F02B 19/108

(57) ABSTRACT

An internal combustion engine, comprising a super-charging, which is designed to compress the charge air into the charge air pipe, with overpressure up to 2.8 BAR, a throttle valve, which operation is to provide a sufficient amount of charge air into the main combustion chamber, while together throttling an overpressure of the charge air from the charge air pipe to achieve a pressure reduction and thus a temperature reduction of the charge air in the intake port up to −20° C. (−4° F.), a cylinder head, which is equipped with a swirl chamber, per main combustion chamber, the size of which is 8% to 15% of the compression volume, whereby the formation of the fuel/air mixture occurs only in this swirl chamber, whereby in combination with the subcooling of the charge air in the intake port, reduces fuel consumption.

The invention relates to a device for the injection of fuel for the internal combustion engines and in particular, to a reciprocating internal combustion engine operating according to the four-stroke method.

Fuel injection is important for all types of internal combustion engines. Fuel is injected directly or indirectly into the combustion chamber of an internal combustion engine operating according to the four-stroke cycle. In the state of the art, direct fuel injection and indirect fuel injection are known. With direct injection, the whole amount of fuel is injected into the main combustion chamber, in which the fuel-air mixture formation and also the combustion of this mixture takes place. Very similar is an internal combustion engine with intake manifold injection. With this method of indirect injection, the fuel is injected into the intake manifold of the internal combustion engine and then sucked by the piston with the air into the main combustion chamber, where combustion takes place. Also known is the pre-chamber injection or swirl chamber injection. In this method, the fuel injection takes place in the pre-chamber, whose size corresponds to 35% to 40% of the size of the main combustion chamber and where the combustion of air-fuel mixture also begins. The expansion forces the remaining fuel into the main combustion chamber, where the main combustion also takes place. For the performance of the internal combustion engine is important not only the injection of fuel, but (among other things) the intake air temperature in the intake port. If this temperature is lower, the efficiency of the internal combustion engine is greater.

In the state of the art, combustion engines are also known which operate with at least one pre-chamber per cylinder, the size of which corresponds to 2% to 15% of the size of the main combustion chamber. These combustion engines work at the ignition point (largely) with a rich fuel-air mixture in the pre-chamber and with the lean mixture in the main combustion chamber. So by ignition and by the burning of the rich mixture in the pre-chamber, a safe ignition of the lean mixture in the main combustion chamber occurs.

In the state of the art (WO 002000070213 A1), an internal combustion engine with intake port fuel injection is known in which the charge air is subcooled in the intake port using the Venturi effect. The subcooling of the charge air in the intake port up to −20° C. (−4° F.) reduces the operation temperature of an internal combustion engine, thus avoid to self-ignition of the fuel-air mixture in the combustion chamber during compression. This advantage, allows the internal combustion engine to work with a higher compression ratio (14:1), to better utilize the energy from the fuel during combustion and to achieve (without increased fuel consumption) an increase of engine power by 200%, compared to the similar engine design, which works without subcooling of the charge air. But, due to the high engine power, the construction of the internal combustion engine is highly stressed, so many components of engine must be made of ceramic materials and it is associated with high acquisition costs. This engine is mainly suitable for the racing cars. The next disadvantage of this engine is the mixture formation in the main combustion chamber. A considerable fuel saving (70%) and a significant reduction in the formation of the carbon oxid (CO₂), whereby only a small reduction in (especially a gasoline) engine output occurs, cannot be achieved if the mixture formation takes place in the main combustion chamber.

The aim of the invention is to provide an internal combustion engine in which, by means of the fuel injection device in combination with the significant subcooling of the charge air in the intake port, a reduction in exhaust emissions is achieved and at the same time saving fuel.

The first step to achieve the objective of the invention is achieved by the fact, that an internal combustion engine is equipped with supercharging, which is designed to compress the charge air into the charge air pipe (in full load) with overpressure up to 2.8 BAR (although only overpressure 0.3 BAR of the charge air in full load, is necessary to achieve optimal operation of an internal combustion engine). The operation of the throttle valve is to provide a sufficient amount of charge air into the main combustion chamber, while at the same time throttling an overpressure of the charge air in the charge air pipe to achieve a pressure reduction of charge air (in full engine load by 2.5 BAR) in the intake port, a result of which a temperature reduction by the Venturi-effect of the charge air in the intake port up to −20° C. (−4° F.). This subcooling of the charge air in the intake port of each cylinder of an internal combustion engine allows this engine to operate with a high (14:1) compression ratio (gasoline engine), better to utilize the energy from the fuel during combustion and to avoid the premature self-ignition of the fuel-air mixture during compression.

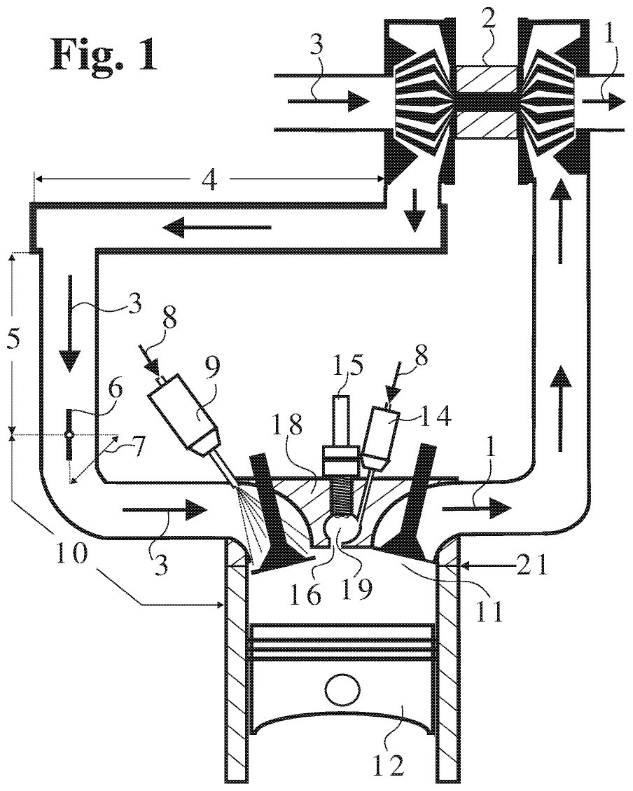

The second step to achieve the objective of the invention is, that an internal combustion engine has in the cylinder head a swirl chamber, or a pre-chamber per each main combustion chamber, the size of which is 8% to 15% of the combined volume of the swirl chamber and main combustion chamber, when the piston is at top dead centre (or in other words, the size of the swirl chamber is 8% to 15% of the compression volume). The volume of the swirl chamber (or of the pre-chamber) in the cylinder head can also be more than 15% of the compression volume, for example 16%, or even more than 16%. Only the swirl chamber (or pre-chamber) is equipped with an injection nozzle and with a spark plug (gasoline engine). For the diesel engines is equipped with an injector and with a glow plug only in the swirl chamber (or in the pre-chamber). The swirl chamber and the main combustion chamber are connected by a firing channel, through which the combustion started in the swirl chamber propagates into the main combustion chamber. Only charge air enters the main combustion chamber (without fuel). There is no fuel in the main combustion chamber even during compression. Thus all fuel is injected only into the swirl chamber (during compression), the size of which is 15% of the compression volume and thus the fuel-air mixture is formed only in this swirl chamber. Because the formation of the fuel-air mixture occurs only in this small swirl chamber (or pre-chamber), the total amount of fuel per piston duty cycle is 70% less, compared to an engine of the same displacement, but with the formation of the fuel-air mixture in the main combustion chamber (FIG. 1). The formation of the fuel-air mixture only in the swirl chamber, the size of which is 15% of the compression volume, allows reliably to ignite and burn 70% less fuel (gasoline) per piston duty cycle (as with the fuel-air mixture formation in the main combustion chamber), even when there is a maximum amount of charge air in the compression volume for full engine load, because the rich fuel-air mixture in the swirl chamber and the charge air in the main combustion chamber, are separated before ignition. There is no need significantly to reduce the volume of charge air in the compression volume when the engine is partly loaded, but only gradually regulate the amount of fuel for mixture formation (reduce or increase the richness of the fuel-air mixture) in the swirl chamber, according to engine power requirements. This technology of the fuel-air mixture formation, allows the internal combustion engine to use high compression pressures in each cylinder even at part load, similar to full load. With this reduction of the fuel consumption (70%), at the same time occurs a reduction (40%) of the operating temperature of the internal combustion engine, but there is no (significant) drop in engine power. The drop in engine power (that would otherwise occur) is compensated by subcooling the charge air with the venturi effect in the intake port of each cylinder up to −20° C. (−4° F.), which allows the use of high compression ratios up to 14:1, without risk of unwanted spontaneous combustion of fuel (pre-ignition) during compression. This technology of the fuel-air mixture formation only in a small swirl chamber, in combination with the subcooling the charge air in the intake port and by use of high compression ratio (14:1), allows to replace the (problematic) fuel-air mixture formation in the main combustion chamber.

According to the invention, an internal combustion engine in the cylinder head is also equipped with two (or more) swirl chambers (or pre-chambers), per cylinder. The size of each swirl chamber is 8% of the compression volume. The volume of a swirl chamber can also be larger (9%) or smaller (7%), than 8% of the compression volume. With two swirl chambers per cylinder, mixture formation in the partial load occurs in only one swirl chamber. In this process it is possible to reliably ignite a 50% smaller amount of fuel per cylinder, in comparison with the internal combustion engine with only one swirl chamber per cylinder (its size is 15% of the compression volume). When the internal combustion engine is under full load, fuel-air mixture formation takes place in the two swirl chambers. Each swirl chamber is connected to the main combustion chamber by a shot channel. Each swirl chamber or pre-chamber must be equipped with an injector and a spark plug (gasoline engine) or with an injector and a glow plug (diesel engine).

The invention is explained in more detail below with reference to the drawings, each illustrating the combustion chamber of an internal combustion engine by means of a schematic diagram. Shown are:

FIG. 1 shows an internal combustion engine (known in the prior art) with the ignition chamber per cylinder, the size of which is 4% of the compression volume and with the mixture formation in the main combustion chamber.

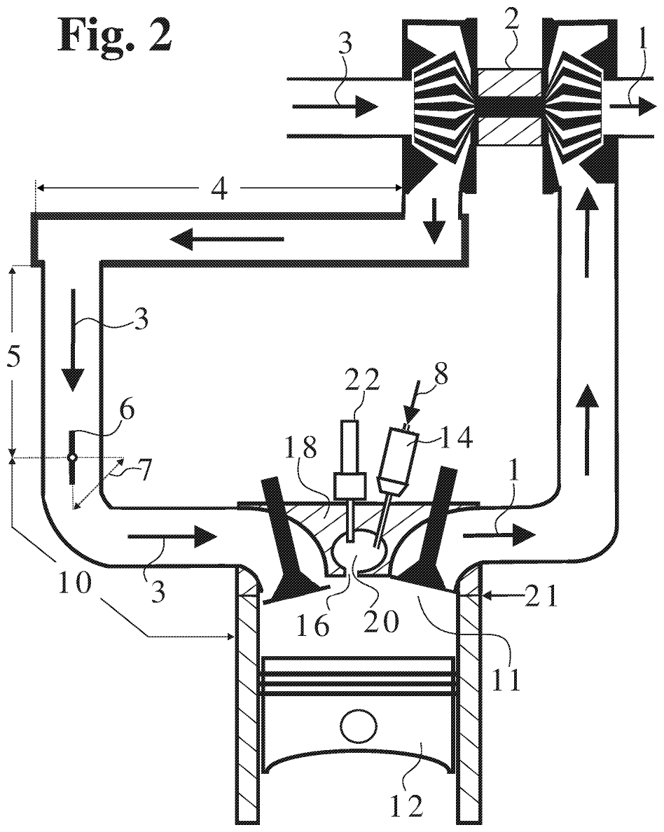

FIG. 2 shows an internal combustion engine (known in the prior art) with the pre-chamber per cylinder, the size of which is 50% of the compression volume, without fuel-air mixture formation in the main combustion chamber.

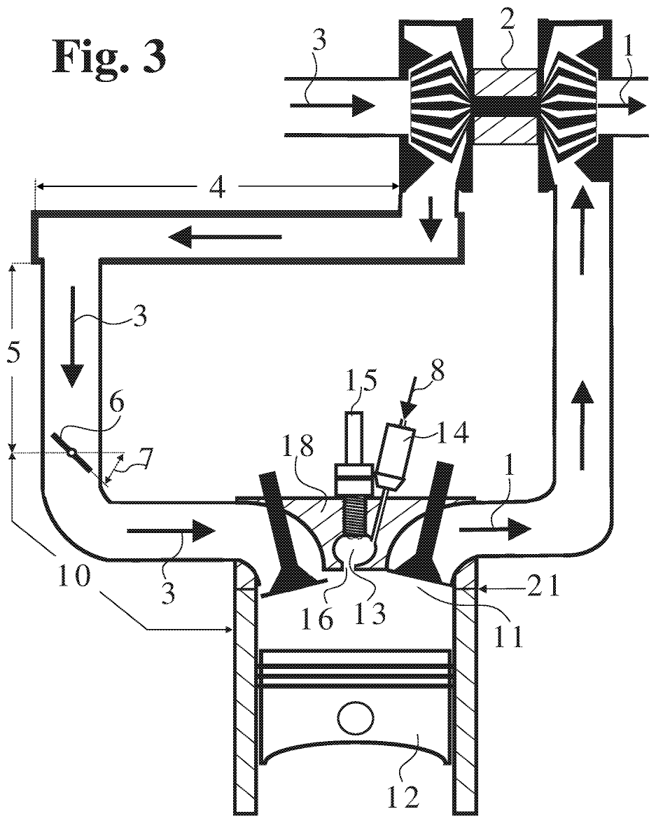

FIG. 3 shows an internal combustion engine (according to the invention) with subcooling of the charge air in the intake port, in combination with the swirl chamber per cylinder, the size of which is 15% of the compression volume, without fuel-air mixture formation in the main combustion chamber.

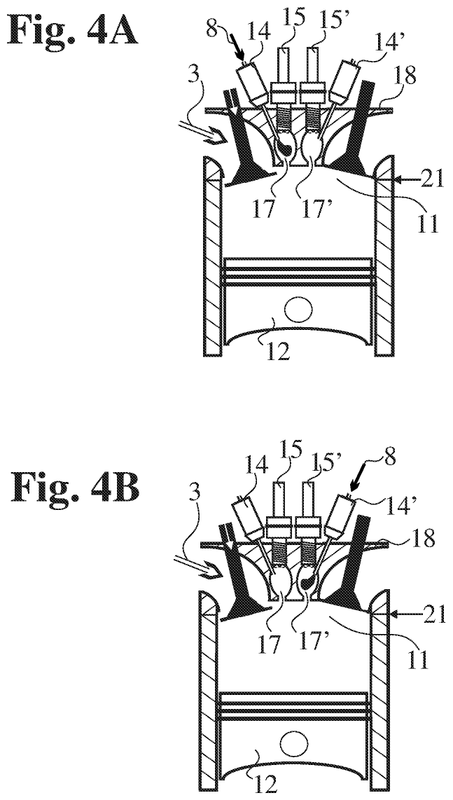

FIGS. 4A and 4B shows an internal combustion engine (according to the invention) with subcooling of the charge air in the intake port, in combination with two swirl chambers per cylinder, the combined size of which is 16% of the compression volume, without fuel-air mixture formation in the main combustion chamber.

FIG. 1 shows an internal combustion engine known in the prior art with the ignition pre-chamber 19 (gasoline engine) and with the supercharging 2. The supercharging 2 (for example, the turbocharger driven by the exhaust gas 1) compresses the charge air 3 with the overpressure of 0.4 up to 0.8 BAR in the full load, through the charge air cooler 4, the charge air pipe 5 and through the intake port 10, into the main combustion chamber 11. The operation of the throttle valve 6 is to provide a sufficient amount of charge air 3 into the main combustion chamber 11, whereby at full load of an internal combustion engine the throttle valve 6 is fully (100%) open 7. The temperature of the charge air 3 in the intake port 10 is more than 40° C. (104° F.). About 95% of the total amount of fuel 8 per operating cycle of the piston 12, is injected into the intake port 10 through the injection nozzle 9 and then the fuel-air mixture is sucked into the main combustion chamber 11 by the piston 12, in which the mixture formation is completed. In the cylinder head 18, one ignition pre-chamber 19 is assigned to each main combustion chamber 11, the size of which is approx. 4% of the combined volume of the pre-chamber 19 and main combustion chamber 11, when the piston is at top dead centre 21. This ignition pre-chamber 19 can be equipped with an injection nozzle 14 and with a spark plug 15. The ignition pre-chamber 19 and the main combustion chamber 11 are connected by a firing channel 16, through which the combustion started in the ignition chamber 19 propagates into the main combustion chamber 11. Approx. 5% of the total fuel 8 quantity per operating cycle of the piston 12 is injected into the ignition chamber 19 through the injection nozzle 14 in order to achieve a rich mixture formation (13:1, air 3+fuel 8) in this ignition pre-chamber 19 and 95% of the total fuel 8 quantity is used for mixture formation in the main combustion chamber 11. With the ignition of the rich mixture in the ignition pre-chamber 19 by spark of the spark plug 15, a reliable ignition of the lean mixture in the main combustion chamber 11 takes place. The problem of this type of internal combustion engine (especially a gasoline engine), is the fuel-air mixture formation in the main combustion chamber 11. A considerable fuel saving (70%) and a considerable reduction (approx.70%) in the formation of the carbon oxid (CO₂), whereby only a minimal reduction in engine output occurs, is not possible to reach, if the fuel-air mixture formation takes place in the main combustion chamber 11.

According to FIG. 2, an internal combustion engine known in the prior art is illustrated with the pre-chamber 20 for the injection of fuel 8 (diesel) and with a supercharging 2. The supercharging 2 (the turbocharger driven by the exhaust gas 1) compresses the charge air 3 with the overpressure 1.5 BAR in the full load, through the intercooler 4, the charge air pipe 5 and through the intake port 10, into the main combustion chamber 11. The throttle valve 6 is fully (100%) open 7 in the full load of an internal combustion engine and the temperature of the charge air 3 in the intake port 10 is more than 40° C. (104° F.). An internal combustion engine has a pre-chamber 20 in the cylinder head 18 per main combustion chamber 11, the size of which is 50% of the combined volume of the pre-chamber 20 and main combustion chamber 11, when the piston is at top dead centre 21 (or of compression volume), whereby the mixture formation takes place only in this pre-chamber 20. The pre-chamber 20 is equipped for diesel injection with the injection nozzle 14 and with the glow plug 22. The pre-chamber 20 and the main combustion chamber 11 are connected by a firing channel 16, through which the combustion started in the pre-chamber 20 propagates into the main combustion chamber 11. But due to a relatively large amount of fuel 8, which is necessary to burn to achieve sufficient power of an internal combustion engine, also the formation of a large amount of the carbon oxid (CO₂) occurs and at the same time the high operating temperature of an internal combustion engine is reached. This high operating temperature combined with high compression ratio (16:1), also causes the formation of the nitrogen oxides (NOx). In this combustion engine, the fuel-air mixture formation does not take place in the main combustion chamber 11, only in the pre-chamber 20, but this pre-chamber 20 must be large enough (50% of the compression volume) for the optimum combustion of the necessary (but relatively large) amount of fuel 8, to achieve the required performance of the internal combustion engine. The (further) disadvantage of this engine is, that with the use of a large pre-chamber 20 (50% of the compression volume) also the large flow losses between the pre-chamber 20 and the main combustion chamber 11 takes place. Furthermore, a considerable fuel saving and a considerable reduction in the formation of the carbon oxid (CO₂), whereby only a minimal reduction in engine output occurs, is not possible to reach, if the fuel-air mixture formation takes place in the large pre-chamber 20, especially if this method of the fuel-air mixture formation is used in the gasoline combustion engine.

FIG. 3 shows an internal combustion engine which, in order to achieve the objective of the invention, operates with a combination of two technologies. Firstly, an internal combustion engine is equipped with a supercharging 2 (for example, the turbocharger driven with the exhaust gas 1), which is designed to compress the charge air 3 through the intercooler 4, into the charge air pipe 5, with overpressure up to 2.8 BAR at full load, although only overpressure 0.3 BAR of the charge air 3 in the intake port 10 at full load, is necessary to achieve optimal operation of an internal combustion engine. Therefore, the operation of the throttle valve 6 is to throttle an excess (overpressure) of charge air 3 from the charge air pipe 5, thus achieving a significant pressure reduction of the charge air 3 (by 2.5 BAR at full load) between the charge air pipe 5 and the intake port 10, but at the same time to provide a sufficient amount of charge air 3 into the main combustion chamber 11, at the same time into the swirl chamber 13. The engine control unit (ECU) monitors the pressure of the charge air 3 in the charge air pipe 5 and adjusts the opening 7 of the throttle valve 6 to this pressure. The greater the pressure of charge air 3 in the charge air pipe 5, the smaller the range of activity (opening) 7 of throttle valve 6. The opening 7 of the throttle valve 6 is only to about 30%, when an internal combustion engine is under full load, in order to achieve throttling and thus a considerable reduction in pressure of the charge air 3 in the intake port 10. With this pressure reduction of the charge air 3 in the intake port 10, at the same time a temperature reduction (a subcooling) of the charge air 3 up to −20° C. (−4° F.) with the Venturi-effect in the inlet port 10 takes place. This subcooling up to −20° C. (−4° F.) of the charge air 3 in the intake port 10, occurs at the full load of an internal combustion engine. This subcooling of the charge air 3 in the intake port 10 up to −20° C. (−4° F.) enables an internal combustion engine to operate at a high compression ratio (14:1), gasoline turbo engine) and to avoid to premature (undesired) self -ignition of the fuel-air mixture during the compression, whereby occurs better utilization of the energy of the fuel during combustion and significantly increase the efficiency of the combustion engine.

Secondly, an internal combustion engine has in the cylinder head 18 a swirl chamber 13, or a prechamber 13 per (each) main combustion chamber 11. The size of this swirl chamber 13 (or a pre-chamber 13) is 8% to 15% of the combined volume of the swirl chamber 13 and main combustion chamber 11 (of compression volume), when the piston 12 is at top dead centre 21. The volume of the swirl chamber 13 (or of the pre-chamber 13) in the cylinder head 18, may also be greater than 15% of the combined volume of the swirl chamber 13 and the main combustion chamber 11, when the piston 12 is at top dead centre 21, for example 16%, or even greater than 16%. Only the swirl chamber 13 (or pre-chamber 13) is equipped with an injection nozzle 14 and with a spark plug 15 (gasoline engine). The swirl chamber 13 and the main combustion chamber 11 are connected by a firing channel 16, through which the combustion started in the swirl chamber 13, propagates into the main combustion chamber 11. The injection of fuel 8 and also the mixture formation (air 3+fuel 8) take place only in this swirl chamber 13 (or pre-chamber 13). Only charge air 3 enters into main combustion chamber 11. Thus, no amount of fuel 8 is in the main combustion chamber 11 during compression of the piston 12 (not even under full engine load), in contrast to the state of the art (FIG. 1). The fuel-air mixture formation only in the swirl chamber 13, the size of which is 15% of the size of the compression volume, makes possible to ignite and to burn about 70% smaller amount of fuel 8 (gasoline) per duty cycle of the piston 12, even when there is a maximum amount of charge air 3 in the compression volume (at full load) , than in an internal combustion engine of the same series, in which the fuel-air mixture is formed in the main combustion chamber 11 (FIG. 1).

With the reduction of the amount of fuel 8 per duty cycle of the piston 12 by 70% (compared to the state of the art, FIG. 1, or FIG. 2), a significant reduction in the formation of the carbon oxid (CO₂) is achieved. The mixture (fuel 8+air 3), which is formed only in the swirl chamber 13, in the full load of an internal combustion engine is very rich (1:8 fuel/air). When a reduction in engine power is required at the partial load, a stepless reduction in the amount of fuel 8 in the mixture (leaning from 1:8 up to 1:14) is effected by the injection nozzle 14 in the swirl chamber 13. If an increase in engine power is required, the fuel/air mixture in the swirl chamber 13 is continuously enriched with fuel 8 (from 1:14 to 1:8). The fuel-air mixture is formed only in the swirl chamber 13, (or in the pre-chamber 13), according to the engine load, whereby the mixture in this swirl chamber 13 is still rich (1:14) even at low engine loads, allowing optimal (fast) fuel 8 combustion over the entire load range of the engine. An internal combustion engine (gasoline) can also use an almost identical amount of charge air 3 in the compression volume (in the main combustion chamber 11 and swirl chamber 13) in the partial engine load, as in the full load, so that the engine can to operate by equally high compression pressure at part load, as in the full load. Exhaust gas recirculation to the main combustion chamber 11, which is used in the current state of the art (FIG. 1) and which causes problematic carbonisation of the engine intake valves, is not necessary.

Another advantage is, that the fuel saving by 70%, also lowers the operating temperature of an internal combustion engine (approx. 40%). This significant reduction of the operating temperature of the combustion engine, in the combination with the subcooling of the charge air 3 in the intake port 10 up to −20° C. (−4° F.), allows the internal combustion engine to operate at a higher compression ratio (16:1) and thus to achieve higher efficiency of the internal combustion engine, than by use only one of these two technologies. When using only one of these two technologies, for example, of the technology of the fuel/air mixture formation only in a small swirl chamber 13, it is possible to use about equaly amount of charge air 3 in the compression volume, when the engine is partly loaded, as when the engine is fully loaded. But without the use of charge air 3 subcooling technology in the intake port 10, the combustion temperature quickly reaches the critical limit 1 500° C. (2732° F.) for the formation of the nitrogen oxides (NOx) and consequently unwanted self-ignition of the fuel-air mixture (gasoline) would occur during compression. Therefore, only a lower compression ratio (11:1) can be used, so the internal combustion engine operates with less efficiency.

On the other hand, only by using the technology of subcooling the charge air 3 in the intake port 10, it is possible to use a high compression ratio (14:1) in an internal combustion engine, without the formation of the nitrogen oxides (NOx) and unwanted self-ignition of the fuel 8 (gasoline) during compression, but as is known from the state of the art, in this type of engine, the formation of the fuel / air mixture takes place in the main combustion chamber 11. For this reason , when the engine is partly loaded, not only the amount of fuel 8 per piston 12 duty cycle must be reduced, but the amount of charge air 3 in the main combustion chamber 11 must also be reduced, in order to achieve the formation of an optimum mixture for reliably igniting a smaller amount of fuel 8 (gasoline). This restriction on the amount of charge air 3 in the main combustion chamber 11, in partly engine load, significantly reduces the compression pressure in each cylinder of the combustion engine and thus its efficiency.

By the combination of both technologies, the above mentioned limitations in the engine operation do not occur. These technologies support each other in such a way that a higher compression ratio (up to 16:1) can be used, than when using only one of the two technologies and thus a significant increase in the efficiency of the internal combustion engine can be achieved. However, the interaction between this two technologies is most effective, at the partial load of the internal combustion engine.

Another advantage is, that the technology of the subcooling of the charge air 3 in the intake port 10, reduces the combustion temperature and thus the formation of nitrogen oxides (NOx). The technology of the fuel-air mixture formation only in a small swirl chamber 13, allows by the combustion of a small amount of fuel 8, to reduce the formation of carbon dioxide (CO₂). By the combination of both technologies in an internal combustion engine, the formation of both unwanted exhaust gases (NOx, CO₂) can be significantly reduced.

FIGS. 4A and 4B shows an internal combustion engine, which works in the same way as an internal combustion engine according to FIG. 3, but with the difference, that the main combustion chamber 11 is provided with two swirl chambers 17, 17′ or with two pre-chambers 17, 17′. The size of the swirl chambers 17, 17′ (or pre-chambers 17, 17′) corresponds jointly 16% of the combined volume of the swirl chambers 17 +17′ and main combustion chamber 11 volume, when the piston 12 is at top dead centre 21. Thus the sum of the volume of the two swirl chambers 17 +17′ and the main combustion chamber 11, when the piston 12 is at top dead centre 21, is the compression volume.

The size of each swirl chamber 17 or 17′ is 8% of the compression volume. The volume of the swirl chambers 17 +17′ (or of the pre-chambers 17, 17′), can be more than 16% of the combined volume of the swirl chambers 17, 17′ and main combustion chamber 11, when the piston 12 is at top dead centre 21. The swirl chamber 17 is equipped with an injection nozzle 14 and a spark plug 15, alike too the swirl chamber 17′ with an injection nozzle 14′ and a spark plug 15′ (gasoline engine). When the engine is fully loaded, fuel 8 is injected into the two swirl chambers 17, 17′ (or into the pre-chambers 17, 17′), in which the injectors 14 and 14′ create a rich fuel-air mixture. In the partial load of the internal combustion engine, fuel 8 is injected only into one swirl chamber 17, but preferably alternately. According to the FIG. 4A, for one working cycle of the piston 12 (4-strokes), the injection of the fuel 8 through the injection nozzle 14 takes place only into the swirl chamber 17 and for the following working cycle of the piston 12 (4-strokes) (FIG. 4B), the injection of the fuel 8 through the injection nozzle 14′ takes place only into the swirl chamber 17′. The alternating fuel injection 8 allows that, the burnt residual gas from the previous working cycle of the piston 12 in the swirl chamber 17 or 17′ is lower (than using only one swirl chamber per main combustion chamber 11, FIG. 3). The injection of fuel 8 only into one swirl chamber 17 or 17′ (the size of which corresponds to about 8% of the compression volume) enables reliable ignition of a 50% smaller quantity of fuel 8 at low load in comparison with an internal combustion engine equipped with only one swirl chamber 13 (or one pre-chamber 13) per main combustion chamber 11, the size of which corresponds to 15% of the compression volume (FIG. 3).

Device for fuel injection for internal combustion engines, specifically the technology of the fuel-air mixture formation only in the swirl chamber 13, the size of which is 15% of the size of the compression volume, in combination with the technology of the subcooling of the charge air 3 in the intake port 10 up to −20° C. (−4° F.), allows to achieve the following advantages in operation of an internal combustion engine:
a considerable fuel saving (up to 70%)
a considerable reduction (approx.70%) in the formation of the carbon oxid (CO₂)
a considerable reduction the formation of the nitrogen oxides (NOx)
Exhaust gas recirculation to the main combustion chamber, is not necessary
the exhaust gas aftertreatment (catalyst, or DPF), is not necessary
the water cooling is not necessary
a reduction of the displacement (downsizing) of an internal combustion engine is not necessary to achieve a reduction of the fuel consumption
cylinder deactivation in an internal combustion engine is not necessary to use in order to achieve fuel savings at partial load.

1. An internal combustion engine equipped with supercharging (2), whereby this supercharging (2) is designed to compress the charge air (3) through the intercooler (4), into the charge air pipe (5) with overpressure up to 2.8 BAR at full load, whereby the operation of the throttle valve (6) is to provide a sufficient amount of charge air (3) into the main combustion chamber (11), while at the same time throttling an overpressure of the charge air (3) from the charge air pipe (5) to achieve a pressure reduction of the charge air (3) in the intake port (10), a result of which a temperature reduction of the charge air (3) in the intake port (10) up to −20° C. (−4° F.) at full load, whereby an internal combustion engine is designed to operate with a high compression ratio 16:1, whereby an internal combustion engine is equipped in the cylinder head (18) with one swirl chamber (13), or with one pre-chamber (13) per main combustion chamber (11), whereby only the swirl chamber (13), or the pre-chamber (13) is equipped with an injection nozzle (14), whereby the fuel-air mixture is formed only in the swirl chamber (13), or in the pre-chamber (13), according to the engine load, whereby in the full engine load, the injection nozzle (14) creates in the swirl chamber (13) a very rich mixture, whereby at part engine load, the proportion of fuel (8) in the mixture in the swirl chamber (13) gradually decreases, whereby into the main combustion chamber (11) only the charge air (3) takes place, whereby the fuel-air mixture in the swirl chamber (13) and the charge air (3) in the main combustion chamber (11) are separated before ignition, characterized in that the volume of the swirl chamber (13), or of the pre-chamber (13) in the cylinder head (18) is 8% to 15% of the combined volume of the swirl chamber (13) and main combustion chamber (11), when the piston (12) is at top dead centre (21).

2. Internal combustion engine according to claim 1, characterized in that the cylinder head (18) is provided with two swirl chambers (17, 17′), or two pre-chambers (17, 17′) per main combustion chamber (11), the size of which corresponds jointly 16% of the combined volume of the swirl chambers (17+17′) and main combustion chamber (11), when the piston (12) is at top dead centre (21).

3. Internal combustion engine according to claim 1, characterized in that the volume of the swirl chamber (13) or of the pre-chamber (13), is more than 15% of the combined volume of the swirl chamber (13) and main combustion chamber (11), when the piston (12) is at top dead centre (21).

4. Internal combustion engine according to claim 1, characterized in that the volume of the swirl chambers (17, 17′) or of the pre-chambers (17, 17′), is more than 16% of the combined volume of the swirl chambers (17, 17′) and main combustion chamber (11), when the piston (12) is at top dead centre (21).
